(19) United States
(12) Patent Application Publication
(10) Pub. No.: US 2012/0187637 A1
(43) Pub. Date: Jul. 26, 2012

(54) SEALING RING AND ARRANGEMENT HAVING A SEALING RING

(75) Inventors: Guenter Kastinger, Gaggenau-Sulzbach (DE); Thomas Singler, Steinach (DE)

(73) Assignee: ROBERT BOSCH GMBH, Stuttgart (DE)

(21) Appl. No.: 13/387,759

(22) PCT Filed: Jun. 1, 2010
(86) PCT No.: PCT/EP10/57628

§ 371 Date: Apr. 16, 2012

(30) Foreign Application Priority Data
Jul. 30, 2009 (DE) 10 2009 028 139.8

(51) Int. Cl. F16J 15/16; F16J 15/32

(52) U.S. Cl. 277/553; 277/500

(57) ABSTRACT

The invention relates to a sealing ring (10) having a first sealing surface (26) arranged on the inner circumference thereof and at least one second sealing surface (13, 14) arranged on the outer circumference thereof. According to the invention, a compensation region (17, 18) that can be at least partially deformed in an elastic manner in the axial direction is arranged on at least one of the two faces of the sealing ring (10).

### BACKGROUND OF THE INVENTION

The invention relates to a sealing ring having a first sealing surface arranged on the inner circumference thereof and at least one second sealing surface arranged on the outer circumference thereof.

A sealing ring of this type is already known in general. In particular, it is inserted into a receiving means of a component in which it is acted upon with force in the axial direction on both end faces. On account of the component tolerances, in particular the tolerances of the receiving means, there is no certainty here that it is made to fit axially in a precise manner. This means that there is either play in the axial direction, i.e. the sealing ring can be displaced in the axial direction, or there is axial pressing. Said pressing leads to deformation of the sealing ring such that the first sealing surface on the radial inner side of the sealing ring can also be deformed, as a result of which the sealing function is impaired. In the extreme case, this means that a sealing of a shaft, for example, cannot be securely guaranteed.

### SUMMARY OF THE INVENTION

Proceeding from the prior art shown, the object underlying the invention is to further develop a sealing ring in such a manner that said sealing ring can be positioned in a fixed manner in the receiving means in the axial direction and any deformation of the sealing ring taking place, for instance, in the axial direction does not impair the sealing function of the first sealing surface. This object is achieved with a sealing ring wherein a compensation region, which can be at least partially deformed in an elastic manner in the axial direction, is arranged on at least one of the two end faces of the sealing ring. In this case, the idea underlying the invention is that a compensation region, which can be at least partially deformed in an elastic manner in the axial direction, is arranged on at least one of the two end faces of the sealing ring. The effect of said axial compensation region is that, with the component tolerances usually provided, an axial displacement of the sealing ring in the receiving means no longer takes place and that the at least one compensation region is able to absorb axial pressing forces which do not result in any deformation of the central region of the sealing ring supporting the second sealing region.

All combinations produced from at least two features disclosed in the description, the claims and/or the figures fall within the framework of the invention. In a particularly preferred embodiment, it is provided that two second sealing surfaces which are spaced apart in an axial manner and are arranged on a central region are provided, and in that the at least one compensation region connects to the central region in the axial direction. This means that a particularly good sealing effect and a radially uniform load of the sealing ring can be achieved.

In order to exclude deformation of the central region even where the central region is realized in a relatively flexible manner, it is provided in a further preferred embodiment that the compensation region is arranged in the region of a central axis of the central region, said central axis extending in the longitudinal direction. This means that no pitching moments or transverse forces that deform the central region can be generated when axial forces occur on the sealing ring.

In a particularly preferred further development of the invention it is provided that a compensation region is arranged in each case on both end faces of the sealing ring. This means axial forces can be transmitted to two compensation regions such that a particularly good springy effect of the compensation regions is achieved. In addition, when there is a sudden occurrence of axial forces from one of the two axial directions, they are absorbed by the respective compensation element before the sealing ring can be axially displaced in the receiving means.

A particularly good adaptation of the first sealing surface to the element to be sealed, for example a shaft, can be brought about when the first sealing surface is arranged on a sealing lip which projects radially inwards from the central region and is elastically resilient in a radial manner.

The axial deformability of the compensation region is ensured when the at least one compensation region has a width which is smaller than the width of the central region.

### BRIEF DESCRIPTION OF THE DRAWINGS

Further advantages, features and details of the invention are produced from the following description of preferred exemplary embodiments and by way of the drawings, in which:

FIG. 1 shows a part longitudinal section of an arrangement of a sealing ring as claimed in the prior art,

FIG. 2 shows a perspective view of a sealing ring as claimed in the invention,

FIG. 3 shows a sectional representation of a detail of the sealing ring in FIG. 2 and

FIG. 4 shows a part longitudinal section through an arrangement having a sealing ring as claimed in the invention as shown in FIG. 2.

### DETAILED DESCRIPTION

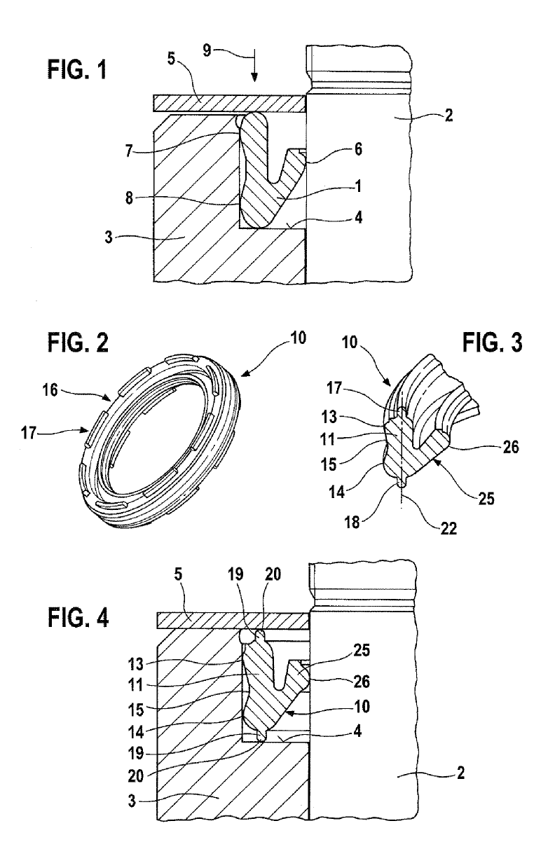

FIG. 1 shows an arrangement having a sealing ring 1 according to the prior art. The sealing ring 1, in this case for example, serves for sealing a shaft 2 which is encompassed at its circumference by an eccentric bush 3. A receiving means 4, which, for example, is L-shaped in part longitudinal section, encompasses the sealing ring 1 in a radial manner and receives said sealing ring also in the axial direction, is realized in the eccentric bush 3. A compensation shim 5 connects to the eccentric bush 3 in the axial direction.

The sealing ring 1 has a first sealing surface 6, which is arranged radially on the inside, and two second sealing surfaces 7 and 8, which are arranged radially on the outside and are spaced apart in an axial manner. FIG. 1 shows the case where the sealing ring 1 protrudes somewhat beyond the receiving means 4 in the eccentric bush 3. When the compensation shim 5 and the eccentric bush 3 are joined axially, the sealing ring 1 can, consequently, be acted upon in the axial direction in the direction of the arrow 9 by a force which leads to a deformation of the sealing ring 1. Said deformation, as a result, can also lead to a deformation of the region of the sealing ring 1 on which the first sealing surface 6 is arranged.

For the case where, on account of the component tolerances, in particular of the eccentric bush 3, this latter has a height in the region of the receiving means 4 that is greater than the axial extension of the sealing ring 1, it is possible, in contrast to this, for the sealing ring 1 to be arranged completely in the receiving means 4, but for said sealing ring not to assume a position there which is clearly defined in an axial manner.

A sealing ring 10 as claimed in the invention is now shown in FIGS. 2 and 3. The sealing ring 10 has a central region 11, on the side of which seen radially on the outside the two second sealing surfaces 13 and 14 are arranged spaced apart in an axial manner. A constriction 15 is realized on the outer circumference of the sealing ring 10 between the two sealing surfaces 13 and 14. The constriction 15 is responsible for ensuring that the sealing ring 10, at its outer circumference, simply abuts against the two second sealing surfaces 13 and 14 in a receiving means of the receiving body. A compensation region 17, 18 connects to the central region 11 in each case, when viewed in the axial direction of the sealing ring 10. Each compensation region 17, 18 has a first region 19 which is rectangular in cross section, to which is connected a second region 20 which is semi-circular in cross section. In this case, the second regions 20 form contact surfaces. In addition, the two compensation regions 17 and 18 lie in the region of a central axis 22 of the central region 11.

As can be seen in particular by way of FIG. 2, the two compensation regions 17, 18, or also only one of the compensation regions 17, 18 can be realized in the radial direction with interruptions 16 such that the compensation regions 17 or 18 are arranged in the manner of segments. This means that possible deformations can be better compensated or homogeneous pressure distributions are achieved.

A sealing lip 25, which supports the first sealing surface 26 on its side protruding radially inwards, is integrally molded onto the central region 11 on the side protruding radially inwards.

The arrangement in FIG. 1 but using a sealing ring 10 as claimed in the invention is now shown in FIG. 4. In this case the compensation shim 5 rests completely on the one end face of the eccentric bush 3. This leads to the two compensation regions 17 and 18 of the sealing ring 10 abutting against the corresponding end face of the compensation shim 5 or the bottom of the receiving means 4. Consequently, axial forces are exerted onto the sealing ring 10 from both axial directions but are absorbed by the two compensation regions 17 and 18, by said regions deforming in an elastic manner and consequently excluding any deforming of the central region 11.

1. A sealing ring (10) having a first sealing surface (26) arranged on the inner circumference thereof and at least one second sealing surface (13, 14) arranged on the outer circumference thereof, characterized in that at least one compensation region (17, 18), which can be at least partially deformed in an elastic manner in an axial direction, is arranged on at least one of two end faces of the sealing ring (10).

2. The sealing ring as claimed in claim 1, characterized in that two second sealing surfaces (13, 14) which are spaced apart in an axial manner and are arranged on a central region (11) are provided, and in that the at least one compensation region (17, 18) connects to the central region (11) in the axial direction.

3. The sealing ring as claimed in claim 2, characterized in that the at least one compensation region (17, 18) is arranged in a region of a central axis (22) of the central region (11), said central axis extending in a longitudinal direction.

4. The sealing ring as claimed in claim 3, characterized in that the at least one compensation region (17, 18) has a contact region (20).

5. The sealing ring as claimed in claim 1, characterized in that a compensation region (17, 18) is arranged in each case on both end faces of the sealing ring (10).

6. The sealing ring as claimed in claim 2, characterized in that the first sealing surface (26) is arranged on a sealing lip (25) which projects radially inwards from the central region (11) and is elastically resilient in a radial manner.

7. The sealing ring as claimed in claim 2, characterized in that the at least one compensation region (17, 18) has a width which is smaller than a width of the central region (11).

8. The sealing ring as claimed in claim 7, characterized in that the compensation region (17, 18) has a rectangular first region (19), to which connects a second region (20) which is semi-circular in cross section.

9. The sealing ring as claimed in claim 2, characterized in that the first sealing surface (26), when viewed in the axial direction, is arranged approximately centrally between the two second sealing surfaces (13, 14).

10. The sealing ring as claimed in claim 1, characterized in that at least one of the compensation regions (17, 18) is realized in the manner of a segment such that free spaces (16) are realized between the individual sections of the compensation regions (17, 18).

11. An arrangement having a sealing ring (10) as claimed in claim 1, characterized in that the sealing ring (10) is acted upon with force on both sides in an axial manner by limiting elements (3, 5).
